(19) United States
(12) Patent Application Publication
(10) Pub. No.: US 2023/0175920 A1
(43) Pub. Date: Jun. 8, 2023

(54) PREDICTING INCIPIENT SEPARATION IN TURBULENT FLOWS

(71) Applicant: UNIVERSITY OF WASHINGTON, Seattle, WA (US)

(72) Inventors: Antonino Ferrante, Seattle, WA (US); Abhiram Aithal, Seattle, WA (US); Dawei Lu, Seattle, WA (US)

(73) Assignee: UNIVERSITY OF WASHINGTON, Seattle, WA (US)

(21) Appl. No.: 17/999,011

(22) PCT Filed: May 18, 2021
(86) PCT No.: PCT/US2021/033003

§ 371 Date: Nov. 16, 2022

Related U.S. Application Data
(60) Provisional application No. 63/027,041, filed on May 19, 2020.

(51) Int. Cl. G01M 9/06; B64F 5/60; G01M 9/08; B64C 1/00; B64C 23/00

(52) U.S. Cl. CPC G01M 9/065; B64F 5/60; G01M 9/08; B64C 1/0009; B64C 23/00

(57) ABSTRACT

A method for predicting if a flow over a smooth ramp surface will separate from the ramp surface, wherein the ramp surface has a slope that is everywhere non-positive along the length of the ramp surface relative to the flow at the inflow end of the ramp surface includes i) dividing the height of the ramp surface by the length of the ramp surface to determine a height-to-length ratio of the ramp surface, ii) identifying a maximum slope magnitude of the ramp surface, iii) calculating a maximum normalized slope by dividing the maximum slope magnitude of the ramp surface by the height-to-length ratio of the ramp surface, and calculating a critical ramp slope as a linear function of the height-to-length ratio of the ramp surface. If the maximum normalized slope is greater than the critical ramp slope, the method predicts the turbulent boundary layer will separate from the ramp surface.

### CROSS-REFERENCE(S) TO RELATED APPLICATION

This application claims the benefit of Provisional Application No. 63/027041, filed May 19, 2019. The entire disclosure of said application is hereby incorporated by reference herein.

### BACKGROUND

Flow separation may occur in a flow having a turbulent boundary layer (TBL) under the effect of adverse pressure gradient (APG). As a TBL develops in space over a curved convex wall, the streamwise average velocity in the boundary layer is reduced by the APG and, eventually, the flow may separate. Incipient separation occurs when the velocity gradient in the wall-normal direction at the wall becomes zero, and, downstream from the separation point, the near-wall streamwise average velocity is opposite to the direction of the outer flow. Separation is accompanied by a thickening of the boundary layer downstream of the separation location, a vortex-filled wake, and increased values of wall-normal component of velocity. The study of flow separation in turbulent flows remains a topic of considerable interest due to its frequent occurrence in practical flows and the inherent uncertainty in modeling. Flow separation may occur, for example, in aerodynamic systems (e.g., flows over airfoils and afterbodies of fuselage), increasing form drag and, potentially reducing lift. Thus, to improve aerodynamic design, it is important for designers to facilitate the prediction of the onset of turbulent flow separation.

Flow separation due to the APG has been investigated in numerous experimental and computational studies. Turbulence measurements around incipient separation for a TBL over a smooth, axisymmetric body exposed to APG have been conducted by Dengel and Fernholz (“An Experimental Investigation of an Incompressible Turbulent Boundary Layer in the Vicinity of Separation,” Journal of Fluid Mechanics, Vol. 212, No. 3, 1990, pp. 615-636). The Dengel and Fernholz experimental study showed the sensitivity of boundary layers to small changes in pressure distributions, which resulted in approximately zero, slightly positive, and slightly negative values of the minimum skin-friction coefficient. The stronger the APG, the more the near-wall momentum decreases, as does the skin-friction coefficient. Without externally imposing a pressure gradient, Hammache et al. (“Whole-Field Velocity Measurements Around an Axisymmetric Body with a Stratford-Smith Pressure Recovery,” Journal of Fluid Mechanics, Vol. 461, June 2002, pp. 1-24.) conducted digital particle image velocimetry (DPIV) measurements on a Stratford's axisymmetric ramp; i.e., the flow over the ramp undergoes a region of APG where the skin friction is continuously zero. For comparison, they also investigated two additional ramps with shorter and longer ramp length corresponding to higher and lower APG than the original Stratford's ramp (“The Prediction of Separation of the Turbulent Boundary Layer,” Journal of Fluid Mechanics, Vol. 5, No. 1, 1959, pp. 1-16). However, it should be noted that the Stratford's ramp studied in Hammache et al. has nearly constant slope, and zero curvature. In contrast, Song et al. (“Experimental Study of a Separating, Reattaching, and Redeveloping Flow over a Smoothly Contoured Ramp,” International Journal of Heat and Fluid Flow, Vol. 21, No. 5, 2000, pp. 512-519) studied experimentally a TBL separating over a circular arc. Recently, Reynolds-averaged Navier-Stokes (RANS) simulations of turbulent flows over curved walls have been performed, and the results compared with the experimental study by Song and Eaton (“Reynolds Number Effects on a Turbulent Boundary Layer with Separation, Reattachment, and Recovery,” Experiments in Fluids, Vol. 36, No. 2, 2004, pp. 246-258). The separation location of flow with incipient or mild separation is determined reasonably well by RANS, whereas it fails in the case of strongly separated flow as the reattachment position is predicted significantly downstream of the experimental position. Coleman et al. (“Numerical Study of Turbulent Separation Bubbles with Varying Pressure Gradient and Reynolds Number,” Journal of Fluid Mechanics, Vol. 847, May 2018, pp. 28-70) also conducted a RANS study where they examined the ability of a range of RANS models to reproduce direct numerical simulation (DNS) data of pressure gradient-induced separation and reattachment of flat plate TBLs. Coleman et al. found that their RANS results for wall quantities remained fairly clustered, even when they deviated appreciably from the reference DNS data. They concluded that there is a lack of understanding of the most widely used and simple RANS models when applied to even moderately complex situations such as turbulent separated flows. Further, the differences in grids and boundary conditions represent an additional source of uncertainty when attempting to compare computational fluid dynamics results.

Incipient separation of turbulent flow over curved convex ramps is described herein, rather than flows over bumps, to focus solely on the effect of APG on the flow imposed by the geometry of the ramps and to avoid the effects of the favorable pressure gradient on the flow. For example, curved convex ramps resemble the aft body of fuselage of many aircraft. As used herein, a curved ramp is defined as “smooth” if the shape of the ramp generating function z(x) (the “ramp function”) and its first derivative are continuous. We investigate the following question: Is it possible to predict the onset of turbulent flow separation over a smooth curved ramp by only knowing a few key parameters related to the ramp geometry, and flow properties of the incoming flow? To answer this question, two-dimensional RANS simulations of TBL flows over smooth curved ramps were performed and studied. The configuration of RANS simulations with respect to the computational domain size, inflow boundary conditions, and grid resolution were verified, and the RANS configurations were validated against experimental results. Finally, turbulent boundary layer ramp flows were investigated using the RANS equations to understand the effects of the ramp geometry and flow parameters on the skin-friction coefficient. From the analysis of the results, a method for predicting separation for turbulent flow over curved ramps that relies only on i) the normalized maximum slope, ii) the height-to-length ratio of the ramp, and iii) the Reynolds number of the inflow were developed. Incipient separation is herein defined to mean that the minimum value of the mean skin-friction coefficient is zero, i.e., C_{fmin}=0.

Methods disclosed herein provide a simple method for predicting if a particular flow will separate from a surface (i.e., produce a local skin-friction coefficient, Cₘᵢₙ equal to zero). For example, in a particular application it is contemplated that the method may be used to design a ramp surface (for example, a surface comprising the aircraft aft fuselage) such that the surface will avoid separation of a design air inflow. For example, the method may be used to design an afterbody section of a fuselage to reduce pressure-drag, thereby increasing the efficiency of the aircraft, and reducing fuel consumption.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method is disclosed for predicting if a flow having a turbulent boundary layer (TBL) and flowing over a smooth ramp surface will separate from the ramp surface, wherein the TBL flow has an inflow Reynolds number (Re_{L}) (based on the length of the ramp surface) at an inflow end of the ramp surface. The ramp surface has a length and a height, and a slope that is everywhere non-positive relative to the TBL flow at the inflow end of the ramp surface. The method includes dividing the height of the ramp surface by the length of the ramp surface to determine a height-to-length ratio of the ramp surface (\tilde{h}), identifying a maximum slope magnitude of the ramp surface, calculating a maximum normalized slope (|\hat{z}′|ₘₐₓ) by dividing the maximum slope magnitude of the ramp surface by the height-to-length ratio of the ramp surface, calculating a critical ramp slope (|\hat{z}′|_{crit}) as a linear function of the height-to-length ratio of the ramp surface, and if the maximum normalized slope is greater than the critical ramp slope, then predicting that the turbulent boundary layer will separate from the ramp surface.

In an embodiment the critical ramp slope is calculated as |\hat{z}′|_{crit}=α\tilde{h}+β, where α=11.82 and β=3.8.

In an embodiment the ramp surface is convex.

In an embodiment the linear function is independent of the inflow Reynold's number.

In an embodiment the linear function is dependent on the inflow Reynold's number.

In an embodiment the critical ramp slope is calculated as |\hat{z}′|_{crit}=α\tilde{h}Re_{L}^{γ}+β, where α=−40.06, β=3.8, and γ=−1/10.

In an embodiment the inflow Reynold's number Re_{L} is raised to a power of −1/10.

In an embodiment the ramp surface has a sloped shape defined by a polynomial function.

In an embodiment the ramp surface has a sloped shape defined by one or more Gaussian functions.

In an embodiment the ramp surface comprises an aerodynamic surface of an aircraft.

In an embodiment the aerodynamic surface is an aft body of a fuselage.

In an embodiment the inflow has a Reynold's number in the range of 2*10⁵ to 8*10⁵.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates aspects of a non-limiting example embodiment of a computational fluid dynamics computing system according to various aspects of the present disclosure.

FIG. 2 is a block diagram that illustrates a non-limiting example embodiment of a computing device appropriate for use as a computing device with embodiments of the present disclosure.

### DETAILED DESCRIPTION

A method is disclosed for predicting if a turbulent boundary layer (“TBL”) flow over a ramp or tapered surface presenting an adverse pressure gradient (“APG”) will separate from the ramp, wherein the ramp is smooth and has a non-positive slope over its entire length. The disclosed method is described in detail in “Law of Incipient Separation over Curved Ramps as Inferred by Reynolds-Averaged Navier Stokes,” AIAA Journal Vol. 59, No. 1, January 2021 (referred to herein as the “AIAA Paper”), which is hereby incorporated by reference in its entirety.

Curved and planar ramp surfaces are common in aerodynamic vehicles and the like. For example, an aft body surface on the tail end of the fuselage of an aircraft may be a ramp surface. A well-designed slope of the fuselage will minimize drag and create a more efficient aircraft, reducing fuel consumption. A method is disclosed to facilitate the selection and/or design of a ramp surface to avoid flow separation of the boundary layer under a design inlet flow by predicting if a particular ramp with a specified inflow to the ramp will separate. In some applications it is desirable to provide a ramp surface that will maintain attachment (not separate) but is designed to operate near to separation conditions, for example to minimize drag. The method disclosed herein may facilitate the design of a ramp that will operate relatively near separation for the specified inflow without producing flow separation.

Prior art methods require relatively complex computational fluid dynamic (“CFD”) simulations to identify one or more ramps that will avoid separated flow under specified inflow conditions. Suitable CFD calculations typically involve numerical simulations of the relevant flow field, for example simulating the two- or three-dimensional Navier Stokes equations. These simulations are typically time consuming and computationally intensive to perform. In a design process, these simulations may be undertaken multiple times to find an acceptable or optimal configuration. It would be beneficial to be able to more efficiently predict if a turbulent boundary layer flow over a ramp will separate from the ramp for a given flow condition, wherein the method does not require simulating the flow field.

Numerical simulations of spatially developing incompressible turbulent boundary layers (“SDTBL”s) with adverse pressure gradient (“APG”) over two-dimensional smooth curved ramps have been performed solving the well-known Reynolds-averaged Navier-Stokes (“RANS”) equations (see the AIAA Paper, referenced above). Ramp geometries studied include ramps based on higher order polynomial functions, ramps based on Gaussian functions, and ramps based on the DARPA Suboff model. Simulations of ramps based on the error function were also modeled and the results were used to verify the present method.

From this investigation a new method for predicting the inception of flow separation in a SDTBL flow over smooth curved ramps for predicting flow separation at very low computational costs was identified. A relatively simple criterion for predicting the inception of SDTBL is disclosed that relies only on geometrical parameters of the ramp, in particular a normalized maximum slope of the ramp and a height-to-length ratio of the ramp, and on the Reynolds number of the inflow.

The inventors performed analyses of smooth curved ramps with different inflow conditions. The effects of the ramp geometry and of the inflow parameters were studied and simulated. The inventors searched for a potential criterion for predicting incipient separation of a turbulent boundary layer flow over curved convex ramps with the goal to answer the question posed above: Is it possible to predict the onset of turbulent flow separation over a smooth curved ramp by only knowing a few key parameters related to the ramp geometry and flow properties of the incoming flow?

A smooth ramp geometry, as used herein, means a ramp having a ramp function profile or height z(x) defining a ramp surface that is continuous and wherein the first derivative of the ramp function profile is continuous. The second derivative may be continuous or not. Ramps are studied wherein the ramp height decreases from a maximum value at the inflow to the ramp to its minimum value at the opposite end of ramp, and the ramp slope is always non-positive. Because we consider only ramps having a zero or negative slope along their length, for any ramp the height z(x) decreases from a maximum value at the inflow end (x/L=0) to a minimum value at the downstream end of the ramp (x/L=1).

A significant number of ramp geometries were analyzed, obtained by different methods, including i) ramps generated with higher order polynomials, ii) ramps generated from Gaussian functions, and iii) ramps based on DARPA Suboff Models. A ramp shape based on the error function was also simulated and used for validation purposes. The specific ramp geometries are described in detail in the incorporated AIAA Paper, and are not repeated here, for clarity. In particular, the method was found to be effective with a broad range of ramp shapes, and therefore the particular ramp shape is not believed to be critical to the present invention, excepting the common characteristics of a smooth ramp having everywhere a non-positive slope, as discussed above.

For a given ramp function profile, increasing the ramp height results in a higher adverse pressure gradient and will eventually lead to flow separation (i.e., skin friction coefficient C_{fmin}<0). Therefore, there is a critical ramp height, h_{crit} for which the flow has an incipient separation at some location on the ramp (i.e., where C_{fmin}=0). The flow will develop differently over different ramp geometries z(x), even ramp geometries with the same ramp height-to-length ratio, h/L. For convenience, the ramp height-to-length ratio is defined as \tilde{h}=h/L.

The effects of slope and curvature profiles for different ramps were also studied. It was found that the ramp's slope affects both the magnitude and the location of the minimum skin friction coefficient C_{fmin}. For flows in which the flow is attached or close to incipient separation the skin friction coefficient C_{f} profile is inversely correlated to the ramp's slope profile, in particular a larger maximum slope leads to a smaller C_{fmin}, and the location of the C_{fmin} is correlated with the location of the maximum slope magnitude |z′|ₘₐₓ. When the flow shows a larger separation region, however, the skin friction coefficient C_{f} profile does not resemble the ramp slope profile and the separation location moves upstream in comparison to the cases in which the separation region is smaller.

It was found that the ramp's curvature affects both the magnitude and the location of the maximum skin-friction coefficient C_{fmax} in the region of favorable pressure gradient in such a way that C_{fmax} occurs at the same location as the maximum curvature and is directly proportional to the maximum curvature.

Therefore, although the maximum curvature controls the magnitude and location of C_{fmax}, the maximum ramp slope |z′|ₘₐₓ, by controlling the magnitude and location of C_{fmin}, is the most important geometrical parameter to determine if the SDTBL flow over the ramp separates, and where the separation will occur.

Flow properties for different Reynolds number flows was also studied (e.g., at Re_{L}=2*10⁵, 4*10⁵, and 8*10⁵). As Re_{L} increases, the flow in the boundary layer has higher streamwise momentum near the wall and consequently the ramp height-to-length ratio \tilde{h} at which the boundary layer separates shifts toward higher values of \tilde{h}, corresponding to higher values of the APG. However, the effect of the inflow boundary layer thickness on the ramp height-to-length ratio \tilde{h} for which C_{fmin}=0 was found to be negligible.

The skin friction coefficient, C_{f}, is correlated with the ramp slope in the region in which the boundary layer undergoes the APG, i.e., where the boundary layer flow is slowed down and may separate. The results from RANS analyses for the different ramp shapes were examined for inflows having Re_{L}=2×10⁵ for critical ramps. We define the maximum normalized slope |\hat{z}′|ₘₐₓ=|z′|ₘₐₓ/\tilde{h}. Then, for the critical ramp, i.e., the ramp having the ramp height-to-length ratio \tilde{h} wherein incipient separation occurs (C_{fmin}=0), the data for the different ramp shapes are found to approximately lie on a linear profile. Obtaining a linear fit for critical ramps indicates incipient separation for curved ramps for Re_{L}=2×10⁵ may be predicted from the absolute value of the critical slope, |\hat{z}′|_{crit}.

|\hat{z}′|_{crit}=α\tilde{h}+β, where α=11.82 and β=3.8. (Eq. 1)

For a given smooth ramp geometry and an Re_{L} of 2*10⁵, if the ramp has a maximum normalized slope |\hat{z}′|ₘₐₓ greater than |\hat{z}′|_{crit}=11.82*\tilde{h}+3.8, the method predicts the flow will separate. Otherwise, the method predicts the flow will not separate.

Similar analyses were then conducted for a plurality of ramps, at different Re_{L} inflows, in particular Re_{L}=2*10⁵, 4*10⁵, and 8*10⁵. The normalized maximum slope of the critical ramps, |\hat{z}′|_{crit}, as a function of the critical height-to-length ratio of the ramps \tilde{h}_{crit} for the Re_{L} were plotted, and it was found that |\hat{z}′|_{crit} is approximately a constant function of \tilde{h}_{crit}.

The data was scaled along the x-axis (\tilde{h}_{crit}) by Re_{L}^{γ} to yield the least fitting error from collapsing the data into a point for each ramp geometry and found a value of γ=−1/10. The small value of the exponent γ=−1/10 indicates that the Reynolds number effect on the value is relatively weak over the range of Reynold's number considered. Obtaining a linear fit for critical ramps indicates incipient separation for curved ramps may be predicted as a function of the inflow Reynolds number, from the absolute value of the critical slope, |\hat{z}′|_{crit}.

|\hat{z}′|_{crit}=α\tilde{h}Re_{L}^{γ}+β, where α=−40.06, β=3.8, and γ=−1/10 (Eq. 2)

For a given smooth ramp geometry, if the ramp has a maximum normalized slope |\hat{z}′|ₘₐₓ greater than |\hat{z}′|_{crit}=−40.06*\tilde{h}*Re_{L}^{-0.1} +3.8, the method predicts the flow will separate. Otherwise, the method predicts the flow will not separate.

The impact of changes in the boundary-layer thickness were also analyzed but found to be negligible.

It has been found that application of linear Eq. 1 and/or linear Eq. 2 may be used to identify a critical maximum ramp slope magnitude for a specified inflow. A prediction of whether the specified inflow will separate from a proposed ramp may then be made by comparing a maximum ramp slope magnitude of the proposed ramp with the critical maximum ramp slope magnitude, without performing a numerical simulation of the flow field. Using Eq. 1, the prediction does not take into account differing Re_{L} (or assumes an inflow Re_{L}=2*10⁵), using Eq. 2 the prediction considers the inflow Re_{L}.

It will be apparent to persons of skill in the art that the disclosed method may be readily adapted to other flows to obtain a linear equation (in the normalized slope \tilde{h}) to obtain a critical ramp slope of the ramp and comparing a maximum normalized slope of the ramp with the critical ramp slope obtained from the linear equation to predict if the flow will separate. For example, linear equations similar to Eq. 1 recited above may be readily obtained for other Reynolds number flows. Such linear equations would have different constants than those recited in Eq. 1.

It will be appreciated by persons of skill in the art that the method disclosed herein significantly reduces the computational complexity for predicting if a proscribed turbulent flow field developing over a ramp will separate from the ramp. Rather than requiring solving the Navier Stokes equations, or the like, predicting separation based on a linear equation, rather than requiring simulation of an entire flow field. The method will be particularly advantageous for computational fluid dynamic software packages, wherein a large number of simulations may be required.

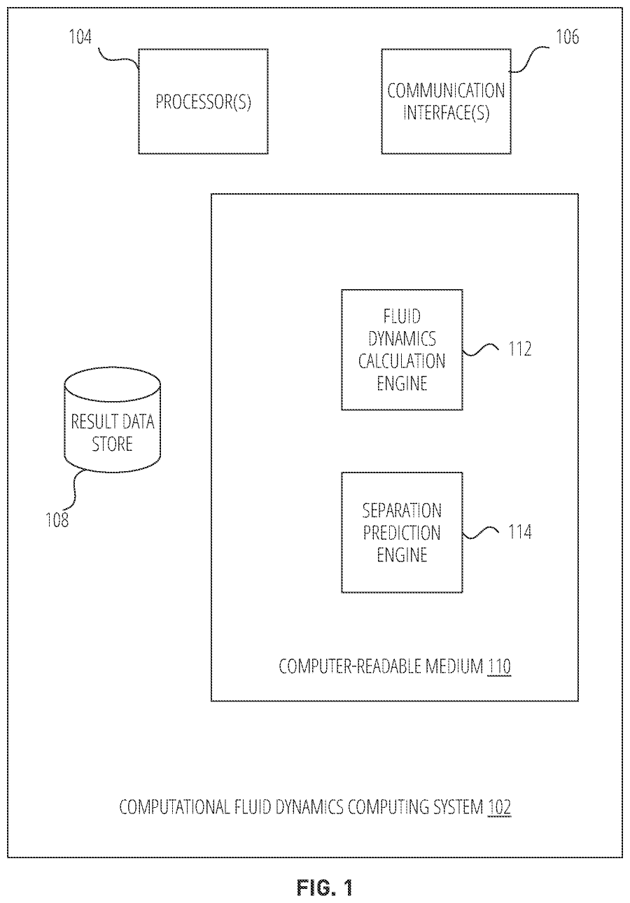

FIG. 1 is a block diagram that illustrates aspects of a non-limiting example embodiment of a computational fluid dynamics computing system 102 according to various aspects of the present disclosure. The illustrated computational fluid dynamics computing system 102 may be implemented by any computing device or collection of computing devices, including but not limited to a desktop computing device, a laptop computing device, a mobile computing device, a server computing device, a computing device of a cloud computing system, and/or combinations thereof. The computational fluid dynamics computing system 102 is configured to conduct simulations of fluid flows, including making determinations of whether a proscribed turbulent flow field developing over a ramp will separate from the ramp.

As shown, the computational fluid dynamics computing system 102 includes one or more processors 104, one or more communication interfaces 106, a result data store 108, and a computer-readable medium 110.

In some embodiments, the processors 104 may include any suitable type of general-purpose computer processor. In some embodiments, the processors 104 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 106 include one or more hardware and or software interfaces suitable for providing communication links between components. The communication interfaces 106 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 110 has stored thereon logic that, in response to execution by the one or more processors 104, cause the computational fluid dynamics computing system 102 to provide a fluid dynamics calculation engine 112 and a separation prediction engine 114.

In some embodiments, the fluid dynamics calculation engine 112 is configured to conduct simulations that involve fluid flows and interactions with surfaces, including but not limited to aerodynamic simulations and hydrodynamic simulations of vehicles or portions thereof traveling through various fluids. In some embodiments, the separation prediction engine 114 is configured to perform a simplified linear calculation as described herein to determine whether a given flow will detach from a surface, so that the computational fluid dynamics computing system 102 can provide such predictions without requiring the fluid dynamics calculation engine 112 to conduct a detailed simulation of the surface. Results of the computations of the fluid dynamics calculation engine 112 and the separation prediction engine 114 may be stored in the result data store 108.

Further description of the configuration of each of these components is provided below.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

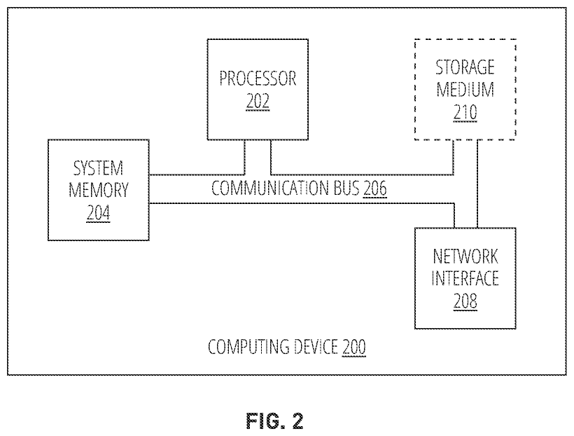

FIG. 2 is a block diagram that illustrates aspects of an exemplary computing device 200 appropriate for use as a computing device of the present disclosure. While multiple different types of computing devices were discussed above, the exemplary computing device 200 describes various elements that are common to many different types of computing devices. While FIG. 2 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Some embodiments of a computing device may be implemented in or may include an application-specific integrated circuit (ASIC), a field-programmable gate array (FPGA), or other customized device. Moreover, those of ordinary skill in the art and others will recognize that the computing device 200 may be any one of any number of currently available or yet to be developed devices.

In its most basic configuration, the computing device 200 includes at least one processor 202 and a system memory 204 connected by a communication bus 206. Depending on the exact configuration and type of device, the system memory 204 may be volatile or nonvolatile memory, such as read only memory (“ROM”), random access memory (“RAM”), EEPROM, flash memory, or similar memory technology. Those of ordinary skill in the art and others will recognize that system memory 204 typically stores data and/or program modules that are immediately accessible to and/or currently being operated on by the processor 202. In this regard, the processor 202 may serve as a computational center of the computing device 200 by supporting the execution of instructions.

As further illustrated in FIG. 2, the computing device 200 may include a network interface 208 comprising one or more components for communicating with other devices over a network. Embodiments of the present disclosure may access basic services that utilize the network interface 208 to perform communications using common network protocols. The network interface 208 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 208 illustrated in FIG. 2 may represent one or more wireless interfaces or physical communication interfaces described and illustrated above with respect to particular components of the computing device 200.

In the exemplary embodiment depicted in FIG. 2, the computing device 200 also includes a storage medium 210. However, services may be accessed using a computing device that does not include means for persisting data to a local storage medium. Therefore, the storage medium 210 depicted in FIG. 2 is represented with a dashed line to indicate that the storage medium 210 is optional. In any event, the storage medium 210 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 202, system memory 204, communication bus 206, storage medium 210, and network interface 208 are known and commercially available. For ease of illustration and because it is not important for an understanding of the claimed subject matter, FIG. 2 does not show some of the typical components of many computing devices. In this regard, the computing device 200 may include input devices, such as a keyboard, keypad, mouse, microphone, touch input device, touch screen, tablet, and/or the like. Such input devices may be coupled to the computing device 200 by wired or wireless connections including RF, infrared, serial, parallel, Bluetooth, Bluetooth low energy, USB, or other suitable connections protocols using wireless or physical connections. Similarly, the computing device 200 may also include output devices such as a display, speakers, printer, etc. Since these devices are well known in the art, they are not illustrated or described further herein.

While illustrative embodiments have been illustrated and described, it will be appreciated that various changes can be made therein without departing from the spirit and scope of the invention.

1. A method for predicting if a flow having a turbulent boundary layer (TBL) and flowing over a smooth ramp surface will separate from the ramp surface, the TBL flow having an inflow Reynolds number (Re_{L}), wherein the ramp surface has a length and a height wherein Re_{L} is based on the length, and further wherein the ramp surface has a slope that is everywhere non-positive along the length of the ramp surface relative to the TBL flow at the inflow end of the ramp surface, the method comprising:
dividing the height of the ramp surface by the length of the ramp surface to determine a height-to-length ratio of the ramp surface (\tilde{h});
identifying a maximum slope magnitude of the ramp surface;
calculating a maximum normalized slope (|\hat{z}′|ₘₐₓ) by dividing the maximum slope magnitude of the ramp surface by the height-to-length ratio of the ramp surface;
calculating a critical ramp slope (|\hat{z}′|_{crit}) as a linear function of the height-to-length ratio of the ramp surface; and
using the critical ramp slope to predict separation of the boundary layer by predicting the turbulent boundary layer will separate from the ramp surface if the maximum normalized slope is greater than the critical ramp slope, and predicting that the turbulent boundary layer will not separate from the ramp surface if the maximum normalized slope is less than the critical ramp slope.

2. The method of claim 1, wherein the critical ramp slope is calculated as:

|\hat{z}′|_{crit}=α\tilde{h}+β, where α=11.82 and β=32 3.8.

3. The method of claim 1, wherein the ramp surface is convex.

4. The method of claim 1, wherein the linear function is independent of the inflow Reynold's number, Re_{L}.

5. The method of claim 1, wherein the linear function is dependent on the inflow Reynold's number, Re_{L}.

6. The method of claim 1, wherein the critical ramp slope is calculated as:

|\hat{z}′|_{crit}=α\tilde{h}Re_{L}^{γ}+β, where α=−40.06, β=3.8, and γ=−1/10.

7. The method of claim 1, wherein the ramp surface has a slope shape defined by a polynomial function.

8. The method of claim 1, wherein the ramp surface has a slope shape determined by one or more Gaussian functions.

9. The method of claim 1, wherein the ramp surface comprises an aerodynamic surface of an aircraft.

10. The method of claim 9, wherein the aerodynamic surface is aft body of a fuselage.

11. The method of claim 6, wherein the inflow Reynold's number is in the range of 2*10⁵ to 8*10⁵.

12. A method for predicting if a turbulent boundary layer (“TBL”) flow over a ramp surface having a height-to-length ratio (\tilde{h}), the flow having a Reynolds number (Re_{L}), will separate from the ramp surface, and wherein the ramp surface has a slope that is everywhere non-positive, the method comprising:
identifying a maximum slope magnitude of the ramp surface;
calculating a maximum normalized slope (|\hat{z}′|ₘₐₓ) by dividing the maximum slope magnitude of the ramp surface by the height-to-length ratio of the ramp surface;
calculating a critical ramp slope (|\hat{z}′|_{crit}) as a linear function of the height-to-length ratio of the ramp surface; and
using the critical ramp slope to predict separation of the boundary layer by predicting the turbulent boundary layer will separate from the ramp surface if the maximum normalized slope is greater than the critical ramp slope, and predicting that the turbulent boundary layer will not separate from the ramp surface if the maximum normalized slope is less than the critical ramp slope.

13. The method of claim 12, wherein the critical ramp slope is calculated as:

|\hat{z}′|_{crit}=α\tilde{h}+β, where α=11.82 and β=32 3.8.

14. The method of claim 12, wherein the ramp surface is convex.

15. The method of claim 12, wherein the linear function is dependent on the Reynolds number, Re_{L}.

16. The method of claim 12, wherein the critical ramp slope is calculated as:

|\hat{z}′|_{crit}=α\tilde{h}Re_{L}^{γ}+β, where α=−40.06, β=3.8, and γ=−1/10.

17. The method of claim 12, wherein the ramp surface has a slope shape defined by a polynomial function.

18. The method of claim 12, wherein the ramp surface has a slope shape determined by one or more Gaussian functions.

19. The method of claim 12, wherein the ramp surface comprises an aerodynamic surface of an aircraft.

20. The method of claim 19, wherein the aerodynamic surface is aft body of a fuselage.
